(19) United States
(12) Patent Application Publication
(10) Pub. No.: US 2026/0335060 A1
(43) Pub. Date: Oct. 29, 2026

(54) DEVICE FOR ARTIFICIAL INSEMINATION OF ANIMALS

(71) Applicant: TECNOVET, S.L., CENTELLES (Barcelona) (ES)

(72) Inventor: Joan MORELL BRAS, CENTELLES (Barcelona) (ES)

(21) Appl. No.: 19/486,223

(22) PCT Filed: Jun. 29, 2023
(86) PCT No.: PCT/EP2023/067836

§ 371 Date: Nov. 20, 2025

(30) Foreign Application Priority Data
May 22, 2023 (EP) 23382474.7

(51) Int. Cl. A61D 19/02

(52) U.S. Cl. CPC A61D 19/027

(57) ABSTRACT

The device for the artificial insemination of animals comprises a cannula (1) to be inserted into the cervix of the animal to be inseminated; an insertion tip (2) placed at one of the ends of the cannula (1), said insertion tip (2) being provided with a hole (7); and a fixing element (3) placed on the cannula (1) for fixing the cannula (1) in position during insemination; and a reinforcing element (10) that reinforces a portion of the cannula (1). It allows to provide an artificial insemination device for animals that is fixed in position but does not disturb the animal during insemination.

The present invention refers to a device for the artificial insemination of animals, which allows its insertion and fixation in position without disturbing the animal.

### BACKGROUND OF THE INVENTION

The application of a seminal dose in animals in heat, particularly in sows, is routinely performed vaginally, using an instrument called a tube-shaped cannula, which, although it can have different shapes, in all cases serves to reach the cervix and be fixed it at its first centimeters, allowing the application through it of the seminal dose, which has to cross the rest of the cervix, until it reaches the cervix.

There are currently several types of cannulas ranging from the classic reusable one made of rubber or similar, to an almost inexhaustible list of single-use plastic cannulas.

The latter are generally made up of three pieces that correspond to the handle, the stem and the end or tip, so that the handle, not present in all cannulas, is a small piece used to handle the cannula easily.

The stem or body of the cannula is a tube approximately 50 centimeters long, which serves as a conduit for seminal fluid, the diameter of said tube being variable, although in no case does its outer dimension exceed 10 millimeters.

The tip, as the main element of the cannula, is a piece of variable size and shape, which in any case makes it possible to insert and fix it in the cervix. There are cylindrical ones (caps), for example, made of foam, and there are conical ones, made of several types of plastics and with highly variable sizes.

A problem with the use of this type of cannulas is that if no fixing element is used, it is not fixed in position and its operation is not correct.

For this reason, the use of fixing elements placed on the cannula is common. In these cases, the attachment to the cervix is normally facilitated thanks to the shape of said fixing elements, which increase the level of coupling between the cannula and the irregularities of the cervical wall. However, the presence of these fixing elements can disturb the animal, which can influence the insemination.

An example of this type of insemination device is disclosed in document WO 2001/049205 A1. This document discloses an artificial insemination device comprising a cannula provided with a tip and a helical-shaped fixing element placed on said cannula.

Another example of this type of insemination device is disclosed in document EP 3725266 A1, in which the cannula has the same rigidity over its entire length.

### DISCLOSURE OF THE INVENTION

Therefore, an objective of the present invention is to provide a device for artificial insemination of animals that is fixed in position but does not disturb the animal during insemination.

With the device for artificial insemination of animals of the invention said disadvantages are solved, presenting other advantages that will be described below.

The device for artificial insemination of animals according to the present invention is described in claim 1, and the dependent claims include additional optional features.

In particular, the device for the artificial insemination of animals comprises:
a cannula to be inserted into the cervix of the animal to be inseminated;
an insertion tip placed at one end of the cannula, said insertion tip being provided with a hole;
a fixing element placed on the cannula to fix the cannula in position during insemination; and
a reinforcing element that reinforces a portion of the cannula.

In this way, the reinforcing element makes a portion of the cannula more rigid than the rest of the cannula, facilitating the insertion of the insemination device according to the present invention.

In addition, said reinforcing element defines an insertion portion in the cannula devoid of the reinforcement element, which insertion portion is less rigid than the reinforced portion of the cannula.

According to one embodiment of the insemination device according to the present invention, the reinforcing element is housed inside a portion of the cannula. Furthermore, said reinforcing element is preferably tubular.

Preferably, the length of the insertion portion is less than the length from the fixing element to the insertion tip. In this way, the reinforcing element extends beyond the fixing element, towards the insertion tip.

According to a preferred embodiment, the fixing element comprises a tubular portion, a first frustoconical portion and a second frustoconical portion, said first and second frustoconical portions being made of a flexible material.

In particular, said first and second frustoconical portions define an end with a larger diameter and an end with a smaller diameter, so that during the insertion of the cannula said ends with a larger diameter are further from the insertion tip and, during the withdrawal of the cannula, said larger diameter ends are closer to the insertion tip.

In addition, said cannula preferably includes an insertion indication.

According to a preferred embodiment, the diameter of the larger diameter end of the first frustoconical portion is smaller than the diameter of the larger diameter end of the second frustoconical portion and said first frustoconical portion is arranged closer to the insertion tip than said second frustoconical portion.

### BRIEF DESCRIPTION OF THE DRAWINGS

For better understanding of what has been disclosed, some drawings in which, schematically and only by way of a non-limiting example, a practical case of embodiment is shown.

FIG. 1 is a perspective view of the device for artificial insemination according to the present invention in its insertion position; and

FIG. 2 is a perspective view of the device for artificial insemination according to the present invention in its removal position.

### DESCRIPTION OF A PREFERRED EMBODIMENT

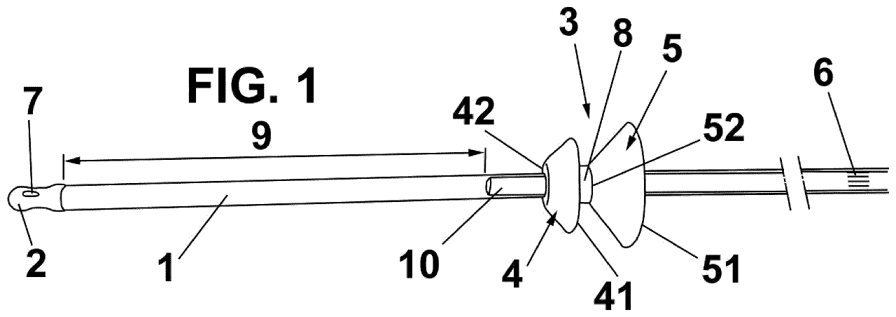

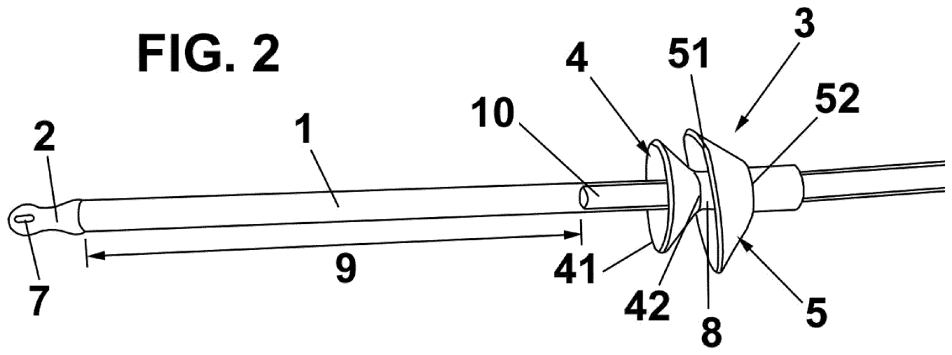

As shown in FIGS. 1 and 2, the device for artificial insemination of animals according to the present invention comprises a cannula 1, which is a tubular element that is inserted into the cervical neck of the animal to be inseminated.

To facilitate its insertion, said cannula 1 includes at one of its ends an insertion tip 2, which includes a hole 7 to allow semen to exit through it for insemination of the animal.

In order to allow the fixation of the cannula 1 in position during the insemination, the insemination device also comprises a fixing element 3 placed on said cannula in a portion thereof.

In addition, the device for artificial insemination of animals also comprises a reinforcing element 10 that reinforces a portion of the cannula 1, causing the stiffness of the reinforced portion of the cannula 1 to increase.

Said reinforcing element 10 defines an insertion portion 9 in the cannula 1 devoid of the reinforcing element 10, which has a lower rigidity than the reinforced portion of the cannula 1, which facilitates the insertion of the cannula for the insemination of the animal.

According to the shown embodiment, the reinforcing element 10 is a tubular element that is housed inside the reinforced portion of the cannula 1.

Furthermore, as can be seen in the figures, the length of the insertion portion 9 is less than the length from the fixing element 3 to the insertion tip 2, that is, the reinforcing element 10 extends beyond the fixing element 3 towards the insertion tip 2, leaving the insertion portion 9 devoid of said reinforcing element 10.

Said fixing element 3 comprises a first frustoconical portion 4 and a second frustoconical portion 5, both frustoconical portions 4, 5 being placed in a tubular portion 8, which is the one that tightly surrounds said cannula 1.

Said frustoconical portions 4 and 5 are made of a flexible material, in such a way that their orientation varies depending on the direction of movement of the cannula 1 and also allows the insertion and removal of the cannula not disturbing the animal.

Said first and second frustoconical portions 4, 5 each comprise a larger diameter end 41, 51 and a smaller diameter end 42, 52, and the diameter of the larger diameter end 41 of the first frustoconical portion 4 is less than the diameter of the larger diameter end 51 of the second frustoconical portion 5.

Furthermore, the first frustoconical portion 4 is positioned closer to the insertion tip 2 than the second frustoconical portion 5.

When the cannula 1 is inserted, said first and second frustoconical portions 4, 5 are oriented as shown in FIG. 1, i.e., with the smaller diameter ends 42, 52 closer to the insertion tip 2 than the larger diameter ends 41, 51.

On the contrary, when the cannula 1 is removed, the orientation of said first and second frustoconical portions 4, 5 changes thanks to the flexible nature of the material. That is, during the removal of the cannula, the larger diameter ends 41, 51 are closer to the insertion tip 2 than the smaller diameter ends 42, 52.

In order to facilitate the correct positioning of the cannula 1, it comprises an insertion indication 6, shown in FIG. 1, for example, some indication lines, which indicate the correct position of the cannula 1 in the insemination position, with a margin error of, for example, 2-3 cm.

Although reference has been made to specific embodiments of the invention, it is apparent to a person skilled in the art that the described device for artificial insemination of animals is susceptible of numerous variations and modifications, and that all the details mentioned can be replaced by other technically equivalents, without departing from the scope of protection defined by the appended claims.

1. A device for the artificial insemination of animals, comprising:
a cannula to be inserted into the cervix of the animal to be inseminated;
an insertion tip placed at one of the ends of the cannula said insertion tip being provided with a hole; and
a fixing element placed on the cannula for fixing the cannula in position during insemination, and
a reinforcing element that reinforces a portion of the cannula.

2. The device for the artificial insemination of animals according to claim 1, wherein said reinforcing element defines an insertion portion in the cannula devoid of the reinforcing element.

3. The device for the artificial insemination of animals according to claim 1, wherein the reinforcing element is housed inside a portion of the cannula (1).

4. The device for the artificial insemination of animals according to claim 1, wherein the length of the insertion portion is less than the length from the fixing element to the insertion tip.

5. The device for the artificial insemination of animals according to claim 1, wherein the fixing element comprises a tubular portion a first frustoconical portion and a second frustoconical portion.

6. The device for the artificial insemination of animals according to claim 5, wherein said first and second frustoconical portions are made of a flexible material.

7. The device for artificial insemination of animals according to claim 6, wherein said first and second frustoconical portions define a larger diameter end and a smaller diameter end so that during the insertion of the cannula said larger diameter ends are further from the insertion tip and, during the removal of the cannula said larger diameter ends are closer to the insertion tip.

8. The device for the artificial insemination of animals according to claim 1, wherein said cannula comprises an insertion indication.

9. The device for the artificial insemination of animals according to claim 7, wherein the diameter of the larger diameter end in the first frustoconical portion is smaller than the diameter of the greater diameter end of the second frustoconical portion.

10. The device for artificial insemination of animals according to claim 7, wherein said first frustoconical portion is arranged closer to the insertion tip than said second frustoconical portion.
